(19) United States
(12) Patent Application Publication
(10) Pub. No.: US 2012/0321808 A1
(43) Pub. Date: Dec. 20, 2012

(54) Soy based spray coating

(76) Inventors: Roy D. Taylor, Woodridge, IL (US); David Grewell, Ames, IA (US); Maria Baboi, Fullerton, CA (US)

(21) Appl. No.: 13/507,250

(22) Filed: Jun. 14, 2012

Related U.S. Application Data
(60) Provisional application No. 61/520,786, filed on Jun. 15, 2011.

(51) Int. Cl. C09D 189/00; B05D 1/18; B05D 1/02

(52) U.S. Cl. 427/427.4; 106/155.21; 427/430.1

(57) ABSTRACT

A coating having source from plant protein that is water insoluble and sprayable. The coating is derived from soy protein or other plants and consists of chemistries that promote water stability and insolubility in water. The spraying device for such coating is an aerosol pressure driven system or similar. The coating converts from a liquid to a solid after a length of time which can be accelerated through heating.

### CROSS REFERENCE TO RELATED APPLICATIONS

This non-provisional utility patent application incorporates by reference the earlier filed provisional patent application, application No. 61/520,786, in its entirety. This non-provisional patent application claims benefit of said copending provisional patent application, effectively filed on Jun. 15, 2011, pursuant to 35 U.S.C. 119(e) and 37 C.F.R. 1.78 (a)(4)-(a)(6) and all other relevant sections of the law not referred to herein.

### FEDERALLY SPONSORED RESEARCH OR DEVELOPMENT

Not applicable.

### REFERENCE TO SEQUENCE LISTING, A TABLE, OR A COMPUTER LISTING APPENDIX

None.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### BACKGROUND OF THE INVENTION

1. Field of the Invention

The present subject matter relates to a soy based spray coating.

2. Background of the Invention

Soy protein based sprays have many advantages over conventional spray coatings, including: being bio-renewable, bio-degradable, non-toxic, and environmentally safe. However, soy protein based sprays have not been realized because of two major issues. First, when soy protein is dissolved in a solvent, such as water, the solution consists of partially dissolved protein as well as of a colloidal system of suspended particles of protein structures. If this system is applied to a substrate through spraying techniques, such as pressure induced aerosols, the resulting coatings are uneven in thickness and non-homogeneous. In addition, because the soy protein is soluble in water, the resulting coatings are sensitive to moisture and can degrade in the presence of moisture. This degradation limits the effectiveness and usefulness of the coating for many applications.

This invention describes a formulation and spraying technique that overcomes these two limitations of soy, as well as other water soluble protein coatings. The coatings are water stabilized through chemical crosslinking of the protein molecules and the spraying technique involves a two-step reaction that allows homogeneous and even thickness.

### SUMMARY OF THE INVENTION

This invention details the use of a cross linking agent, cyclic amide condensate, to chemically crosslink soy protein coatings. Soy protein of various forms can be used depending on the required protein concentration, such as soy protein isolate (approx. 90% protein), soy protein concentration (approx. 70% protein), or soy flour (approx. 40-60% protein). In addition, this technique can work with various water soluble proteins.

The technique involves dissolving the crosslinking agent in water at room temperature, then adding the soy protein to a desired level. This mixture is continuously stirred until it is a stable solution and the soy protein is fully dissolved.

Once the soy protein is dissolved, the solution is heated to approximately 100-150° F. and then transferred to a spraying apparatus, such as a pressure driven aerosol gun, and sprayed. The coating is then allowed to cure for 24 hours.

Increased flexibility can be achieved through the addition of flexibilizers such as glycerin or other compounds.

### BRIEF DESCRIPTION OF THE DRAWINGS

Not applicable.

### DETAILED DESCRIPTION OF THE PREFERRED EMBODIMENTS

This invention details the use of a crosslinking agent, such as BERSET® 2700 cyclic amide condensate, to chemically crosslink soy protein coatings. The technique involves dissolving the crosslinking agent in water at a concentration of approximately 3% by volume of the crosslinking agent at a temperature between 60 and 90° F. This solution is mixed for approximately 2 minutes to assure dissolution. Soy protein is then slowly added to the solution at a concentration of approximately 10% by weight. This mixture is continuously stirred until the mixture is a stable solution and the soy protein is fully dissolved, which typically requires 5 minutes. The solution is heated to approximately 100-150° F. and maintained at this temperature for approximately 5 minutes. The solution is then allowed to cool to a temperature between 60 and 90° F. and then transferred to a spraying apparatus, such as a pressure driven aerosol gun, and sprayed. The coating is then allowed to cure for 24 hours.

Increased flexibility can be achieved through the addition of flexibilizers, such as glycerin or other compounds, at concentration typically between 0.5 to 5% by weight.

The invention claimed is:

1. A water soluble protein coating, comprising:
thermally activated cross-linking agent,
water soluble protein,
and plasticizing agent.

2. A mixture according to claim 1 wherein said protein is soy protein.

3. A mixture according to claim 1 wherein said protein is soy protein isolate.

4. A mixture according to claim 1 wherein said protein is soy protein concentrates.

5. A mixture according to claim 1 wherein said protein is soy flour.

6. A mixture according to claim 1 wherein said cross-lining agent is cyclic amide condensate.

7. A mixture according to claim 1 wherein said plasticizing agent has a concentration from 0% to 5% by weight.

8. A mixture according to claim 1 wherein is sprayed to substrates by pressure driven aerosol device.

9. A mixture according to claim 1 wherein is applied to substrates by dip coating.

10. A mixture according to claim 1 wherein is sprayed to substrates by brush application technique.

11. A process of producing a water stable coating from water soluble protein comprising of:
thermally activated cross-linking agents,
water soluble protein,
and plasticizing agent.

12. A process according to claim 11 wherein said protein is soy protein.

13. A process according to claim 11 wherein said protein is soy protein isolate.

14. A process according to claim 11 wherein said protein is soy protein concentrates.

15. A process according to claim 11 wherein said protein is soy flour.

16. A process according to claim 11 wherein said cross-lining agent is heated to a temperature that initiated chemical cross linking reaction.

17. A process according to claim 11 wherein said cross-lining agent is cyclic amide condensate.

18. A process according to claim 17 wherein said cross-lining agent is added to water to a concentration of 0.1% to 5% by volume.

19. A process according to claim 18 wherein said cross-lining agent is heated to a temperature of at between 100 and 200 F, but typically to 150 F.

20. A process according to claim 18 wherein said solution is applied to substrate immediately after preparation, typically within 30 minutes, and is sprayed to substrates by pressure driven aerosol device.

21. A process according to claim 18 wherein said solution is applied to substrate immediately after preparation, typically within 30 minutes, and is sprayed to substrates by air powered spraying device.

22. A process according to claim 18 wherein said solution is applied to substrate immediately after preparation, typically within 30 minutes, and is applied to substrates by dip coating.

23. A process according to claim 18 wherein said solution is applied to substrate immediately after preparation, typically within 30 minutes, and is sprayed to substrates by brush application technique.

24. A process according to claim 11 wherein said solution agent is cooled to a temperature of less than 100 F, but typically 65 F.

25. A process according to claim 11 wherein said plasticizing agent has a concentration from 0% to 5% by weight

26. A process according to claim 11 wherein is sprayed to substrates by pressure driven aerosol device.

27. A process according to claim 11 wherein is applied to substrates by dip coating.

28. A process according to claim 11 wherein is sprayed to substrates by brush application technique.
